(19) United States
(12) Patent Application Publication
(10) Pub. No.: US 2020/0337498 A1
(43) Pub. Date: Oct. 29, 2020

(54) GRILL WITH A MULTI-PART TILTABLE CHARCOAL GRATE HAVING A CHIMNEY EFFECT

(71) Applicant: VAUSTIL GmbH, Wien (AT)

(72) Inventors: Christoph HERMANN, Wien (AT); Martin WEIGAND, Wien (AT)

(21) Appl. No.: 16/956,445

(22) PCT Filed: Dec. 20, 2018
(86) PCT No.: PCT/EP2018/086315

§ 371 Date: Jun. 19, 2020

(30) Foreign Application Priority Data
Dec. 20, 2017 (AT) A 489/2017

(51) Int. Cl. A47J 37/07

(52) U.S. Cl. CPC A47J 37/0731; A47J 37/0786; A47J 37/0704

(57) ABSTRACT

A grilling device has a body, a cooking grate and a charcoal grate. The charcoal grate has a top side and a bottom side, is permeable to air, and has at least two parts. The at least two parts are tiltably arranged and, in the tilted position, form a space for fuel. The charcoal grate has holes on the top side and on the bottom side.

The present invention relates to a grill.

Grills are popular cooking facilities for gently cooking meat and vegetables using low amounts of fat. Grills can be heated by different heating methods, e.g., using electricity, gas, briquettes or (char)coal. If charcoal is used for heating, igniting the coal often poses a problem. Coals may be stacked and starters may be used to light them. This often results in the coals glowing unevenly, which is undesired. A hair dryer may be used for fanning the embers, distributing it more evenly throughout the stack of coals. Alternatively, an external chimney starter can be used for igniting the coals inside it. The coal is added to the chimney having air holes at its bottom and on its sides. A starter is lighted at the bottom. The chimney effect results in heating and setting aglow the coals evenly. As soon as there are sufficient embers, the chimney starter is emptied and the coals are distributed over the charcoal grate.

As mentioned above, the methods for igniting coals have many disadvantages: either the embers are incomplete or unevenly distributed, which results in undesired cooler regions, or an additional external device, such as a fan or a chimney starter, has to be used. The chimney starter also requires special protective measures, after it has been emptied, to make sure that people around the grill, in particular children, and animals will not get hurt, as the chimney starter will, of course, get very hot during its use.

It is an object of the present invention to provide a grill in which coals in the grill can be easily lighted and efficiently set aglow.

According to the invention this is achieved by providing a grill comprising a body, a cooking grate and a charcoal grate, said charcoal grate having a top side and a bottom side and being permeable to air, having at last two parts, said at least two parts being arranged tiltably and forming a space for fuel in their tilted positions, and having holes in its top and bottom sides.

The division of the charcoal grate into at least two parts that are arranged tiltably has the advantage that the two parts can be tilted upwards. They may thus form a “V” into which coals or briquettes can be added; the coals and briquettes may then be lighted in this position. This creates a chimney starter that is formed by the grill itself. Air can flow in from the sides and from below, resulting in a chimney effect that allows for setting the coals or briquettes completely aglow.

The “at least two parts” also guarantee that the charcoal grate consists of more than three parts, e.g., of 4, 5, 6, 7, 8, 9 or 10 parts. The charcoal grate may be angular- or round-shaped. In an angular-shaped embodiment, two parts are preferred.

The at least two parts may consist of wires that are connected to form a lattice, of rods, of single metal or ceramic plates, of embossed sheet metal or expanded metal.

In another embodiment of the invention, the at least two parts may be tiltable at an angle of 0° to 90° in relation to the use level. This allows for forming an efficient chimney starter.

In one embodiment of the invention, said at least two parts can be attached tiltably to the body my means of round bolts. The bolts create a fixed rotational axis around which the outer parts can be tilted upwards to form the chimney starter.

In one embodiment, said at least two parts can be held in their tilted positions by a movable bolt or a movable rod and said at least two parts can be releasable by moving said bolt or said rod, being movable into an essentially non-tilted position by the effect of gravity. This allows for simply changing the charcoal grate's position.

In another embodiment of the invention, said at least two parts may have suitable recesses with which the round bolts engage and which allow for tilting and a displacement, and said at least two parts being optionally held in their tilted positions by a locking mechanism. The recesses allow for horizontally displacing said at least two parts, so that they can b tilted in another position. This allows for a more flexible use of the charcoal grate. The recesses may, for example, be elongated holes or T-shaped holes.

In one embodiment, at least one damping element can be arranged on the body, on the at least two parts or on the round bolts, said damping element decelerating the movement of the at least two parts from their tilted positions into their essentially non-tilted positions, thus preventing the fuel from becoming undesirably scattered. This allows for moving the charcoal grate more slowly into the essentially non-tilted position, i.e. the essentially horizontal position, which minimizes any shifting of the coals.

In one embodiment the grill may comprise at least one third part, removably arranged on a holding device attached to the body and serving as a support surface for the fuel. The third part may consist of wires that are connected to form a lattice, of rods, of single metal or ceramic plates, of embossed sheet metal or expanded metal.

A division of the charcoal grate into at least three parts, the outer two parts being tiltably arranged, has the advantage that the outer parts can be tiled upwards. This allows for creating a cut-off “V” into which the coals or the briquettes can be added and where they may be lighted. Thus, a chimney starter is created, formed by the grill itself. Air can flow in from below and from the sides, creating a chimney effect that allows for setting the coals or briquettes completely aglow.

The “at least three parts” guarantee that the charcoal grate consists of more than three parts, e.g., 4, 5, 6, 7, 8, 9 or 10. The charcoal grate may thus be angular-shaped or round. In an angular-shaped embodiment, three parts are preferred, as this facilitates the distinction of outer and center parts. In case of a round charcoal grate that may be circular or ellipsoid, a quadrilateral, preferably a square, can be inscribed into the circle or the ellipsis as center part, the corners of said quadrilateral not contacting the circle or the ellipsis, i.e. the circle or the ellipsis is not the quadrilateral's circumscribed circle. Those parts that are directly adjacent to the edges of the inscribed quadrilateral are the tiltably arranged parts and may be tilted upwards in order to be used as a chimney starter. Those parts that abut against the corners of the quadrilateral remain in their initial positions, just like the quadrilateral, thus forming the center part parallel to the use level. In case of a round charcoal grate having an inscribed quadrilateral, the round charcoal grate thus consists of at least nine parts.

In one embodiment, the third part may be removably arranged on sheet metal. It can thus be easily removed.

In one embodiment directional baffles for the coals may be arranged on the body. The directional baffles may make the coals slide easily into a coal collecting area

In one embodiment the charcoal grate can be hollow. This allows for light-weight construction.

In one embodiment the grill may comprise an ash pan. This allows for quickly and easily removing ash from the grill.

In another embodiment of the invention, carrying handles can be arranged on the center part. The carrying handles allow for easily removing the center part. The carrying handles can be thermally insulated.

In another embodiment of the invention, the holes on the bottom side of the charcoal grate can be larger than those on its top side. This allows for an improved air circulation.

In another embodiment of the invention, the body may comprise a pull-out starter pan. A starter can be placed in the starter pan, such as a traditional cube-shaped grill lighter or a piece of wood or burning paper. The starter pan can then be pushed into the grill, and the starter then lights the coal. The starter pan can be very delicate, as the coals fall through the starter pan into the ash pan, when the grill is emptied.

In one embodiment, limiting members that form the space for the fuel together with the top side of the at least two parts can be arranged on the at least two parts. This allows for forming a starter chimney enclosing the fuel using only a few movable parts in the grill. The limiting members can consist of wires connected to form a lattice, of rods, of single metal or ceramic plates, embossed sheet metal or expanded metal. The limiting member may be essentially parallel to the body.

In a further embodiment of the invention, the directional baffle may have four bends forming four angles α, β, γ and δ and may be defined in a direction from the outside to the inside:

starting from an approximately horizontal part of the directional baffle, there is an upward bend forming the angle α, followed by a bend in an approximately horizontal direction forming the angle β, followed by a downward bend forming the angle γ, followed by a bend approximately in a horizontal direction forming the angle δ, the expressions “horizontal”, “upward” and “downward” being defined in relation to the use level,
the angles α, β, γ and δ being defined as follows:
α=110° to 130°, preferably 115° to 125°, especially 120°;
β=110° to 130°, preferably 115° to 125°, especially 120°;
γ=110° to 130°, preferably 115° to 125°, especially 120°;
δ=110° to 130°, preferably 115° to 125°, especially 120°.

This embodiment of the directional baffle having four bends defining the above-mentioned angles results in the efficient removal of burnt coal or burnt briquettes. After having removed the center part, the outer parts are tilted upwards, the coals sliding downwards along the directional baffle and falling into the ash pan. This provides for an easier removal of the used coal.

In a further embodiment of the invention, the directional baffle is symmetrical to the directional baffle and has four bends that form four angles α′, β′, γ′ and δ′ and are defined as follows in a direction from the outside to the inside:

starting from an approximately horizontal part of the directional baffle there is an upward bend forming the angle α′, followed by a bend approximately in a horizontal direction forming the angle β′, followed by a downward bend forming the angle γ′, followed by a bend in an approximately horizontal direction forming the angle δ′, the expressions “horizontal”, “upward” and “downward” being defined in relation to the use level,
the angles α′, β′, γ′ and δ′ being defined as follows
α′=110° to 130°, preferably 115° to 125°, especially 120°;
β′=110° to 130°, preferably 115° to 125°, especially 120°;
γ′=110° to 130°, preferably 115° to 125°, especially 120°;
δ′=110° to 130°, preferably 115° to 125° especially 120°.

This embodiment of the directional baffle having four bends defining the above-mentioned angles results in an efficient removal of the burnt coal or the burnt briquettes. After having removed the center part, the outer parts are tilted upwards, the coals sliding downwards along the directional baffle and falling into the ash pan. This provides for an easier removal of the used coal.

In another embodiment of the invention, the sheet metal may have two bends that form two angles φ and ψ and are defined as follows in a direction from the outside to the inside:

starting from an approximately horizontal part of the sheet metal there is a downward bend forming the angle φ, followed by a bend in an approximately vertical direction forming the angle ψ,
the expressions “vertical” and “downward” being defined in relation to the use level, the angles φ and ψ being defined as follows:
φ=140° to 160°, preferably 145° to 155°, especially 150°;
ψ=110° to 130°, preferably 115° to 125°, especially 120°.

This embodiment of the sheet metal having the above-mentioned angles and its combination with the directional baffles provides an efficient way of discharging used coals. The outer parts are tilted upwards, which allows the coals to slide into the ash pan.

In another embodiment of the invention, the sheet metal may be symmetrical to the sheet metal and has two bends that form the angles φ′ and ψ′ and are defined as follows in a direction from the outside to the inside:

starting from an approximately horizontal part of the sheet metal there is a downward bend forming the angle φ′, followed by a bend in an approximately vertical direction forming the angle ψ′,
the expressions “vertical” and “downward” being defined in relation to the use level, the angles φ′ and ψ′ being defined as follows:
φ′=140° to 160°, preferably 145° to 155°, especially 150°;
ψ′=1108 to 130°, preferably 115° to 125°, especially 120°.

This embodiment of the sheet metal having the above-mentioned angles and its combination with the directional baffles provides an efficient way of discharging used coals. The outer parts are tilted upwards, which allows the coals to slide into the ash pan.

In one embodiment of the invention, the ratio of (the vertical distance between the top side of the outer part and the section of the directional baffle before the first bend) a and (the distance between the outer part and the section of the directional baffle between the first and second bends, measured in an orthogonal direction in relation to the section of the directional baffle between the first and second bends) b a:b in the serviceable state is approx. 7-11:11-15, preferably approx. 4-5:6-7, especially approx. 9:13. When the distance is selected in this way, the coals are prevented from not falling into the ash pan.

In another embodiment of the invention, a may be approx. 7-11 mm, preferably approx. 8-10 mm, especially approx. 9 mm, and b may be approx. 11-15 mm, preferably approx. 12-14 mm, especially approx. 13 mm. As the size of the coals remains the same when the grill is resized, the distances do not have to be adjusted proportionally and the absolute dimensions can be maintained. The absolute dimensions have proved advantageous in combination with commercially available coals, independently of the grill's size.

In one embodiment of the invention, the ratio of (the vertical distance between the top side of the outer part and the section of the directional baffle before the first bend) a′ and (the distance between the outer part and the section of the directional baffle between the first and second bends, measured in an orthogonal direction in relation to the section of the directional baffle between the first and second bends) b′ in the tilted state of the outer parts at a tilt angle of approx. 70° a′:b′ is approx. 1-5:4-8, preferably approx. 2-4:5-7, especially approx. 1:2. When the distance is selected in this way, the coals are prevented from not falling into the ash pan.

In another embodiment of the invention, a′ may be approx. 1-5 mm, preferably approx. 2-4 mm, especially approx. 3 mm; and b′ may be approx. 4-8 mm, preferably approx. 5-7 mm, especially approx. 6 mm. The absolute dimensions have proved advantageous in combination with commercially available coals, independently of the grill's size.

### BRIEF DESCRIPTION OF THE DRAWINGS

FIG. 1 shows a grill of the invention.

FIG. 2 shows a cross section along a longitudinal axis of a grill of the invention in the serviceable state.

FIG. 3 shows a cross-section along a longitudinal axis of a grill of the invention having a tilted charcoal grate, illustrating a starter position or an emptying position.

FIG. 4 shows an embodiment of the invention having a damping element, movable bolts and a locking mechanism.

FIG. 5 schematically illustrates the angles of the directional baffles.

FIG. 6 schematically illustrates the angles of the sheet metals.

FIG. 7 schematically illustrates the distances between the outer part of the charcoal grate and the directional baffle in the serviceable state and in the tilted state.

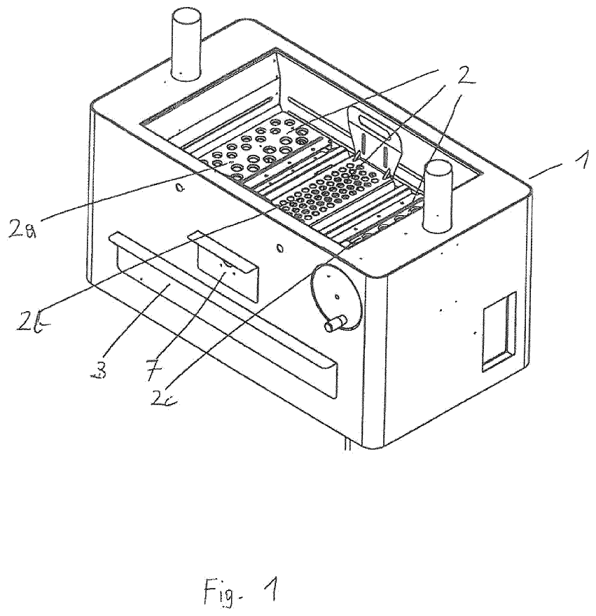

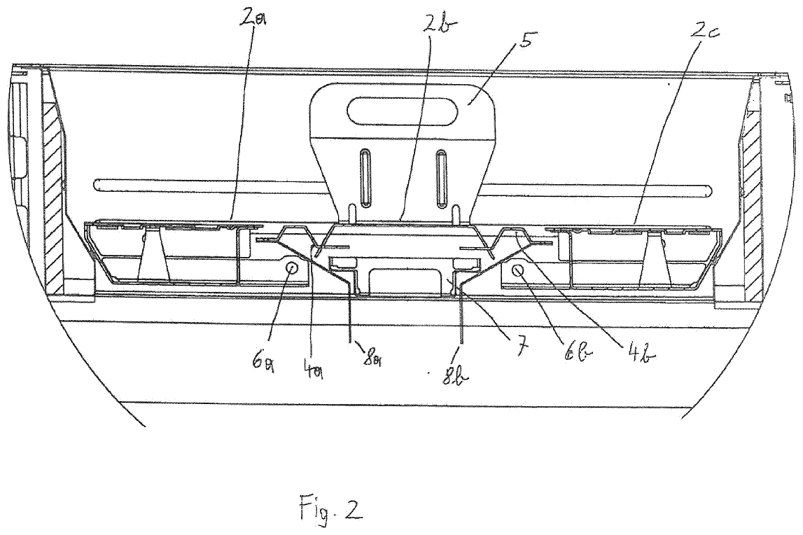

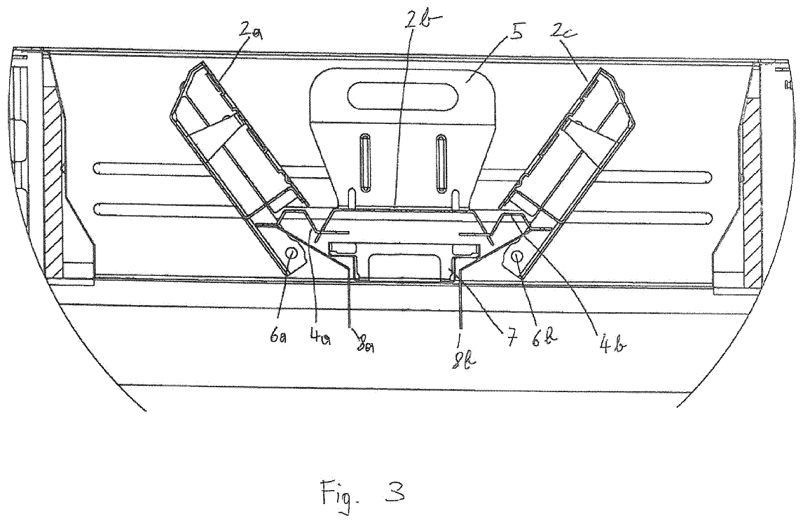

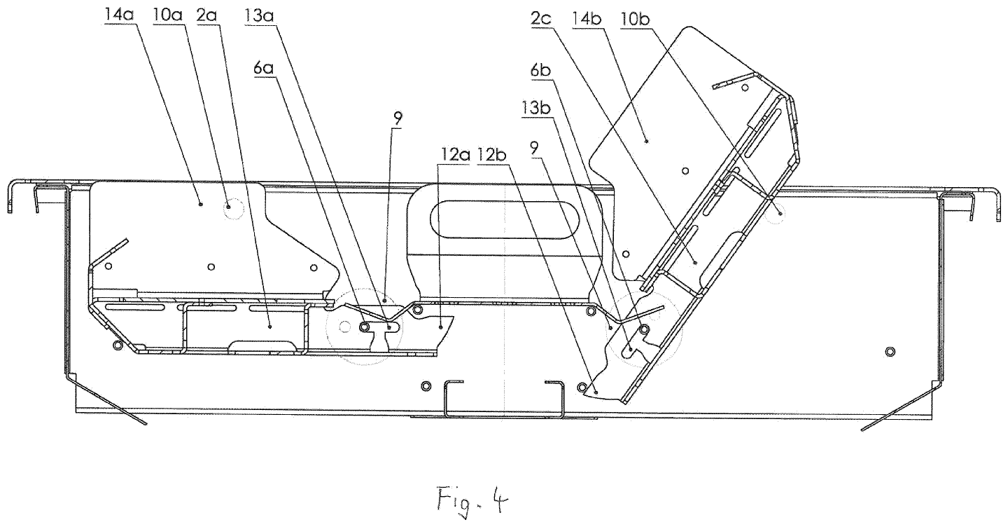

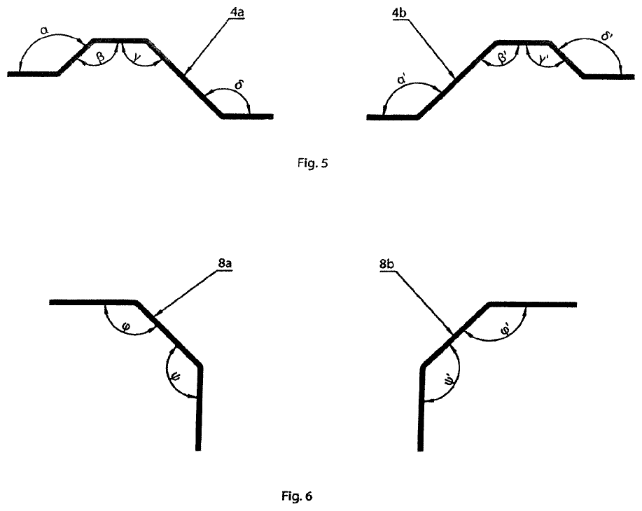

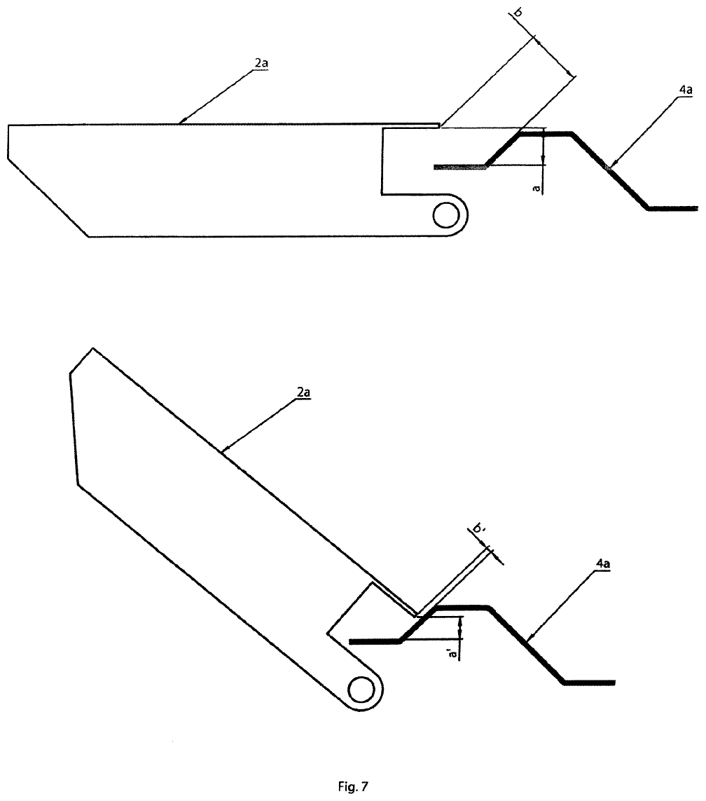

The numerals mean:
1 body
2 charcoal grate
2a, 2c outer parts of the charcoal grate
2b center part of the charcoal grate
3 ash pan
4a, 4b directional baffles
5 carrying handles
6a, 6b bolts
7 starter pan
8a, 8b sheet metal
9 damping element
10a, 10b movable bolts and rods
12a, 12b locking mechanism
13a, 13b recesses
14a, 14b limiting members

### EXAMPLES

### Example 1

Grill

The grill comprises a body 1, a cooking grate and a charcoal grate 2, said charcoal grate 2 having a top side and a bottom side and being permeable to air, having at least two parts 2a, 2c, said at least two parts 2a, 2c being disposed tiltably and forming a space for fuel in their tilted position, and having holes on its top and bottom sides

A division of the charcoal grate 2 into at least two parts 2a, 2c that are disposed in a tiltable way has the advantage that the two parts 2a, 2c can be tilted upwards. This way, a “V” into which coals or briquettes may be added and where coals or briquettes can be lighted may be formed. This creates a starter chimney that is formed in the grill itself. Air can flow in from the bottom and the sides and create a chimney effect that allows for setting the coals or briquettes completely aglow.

The at least two parts 2a, 2c can consist of wires that are connected to form a lattice, of rods, of single metal or ceramic plates, of embossed sheet metal or of expanded metal.

The at least two parts 2a, 2c can be tiltable at an angle of 0° to 90° in relation to the use level. This allows for forming an efficient chimney starter.

The at least two parts 2a, 2c can be arranged tiltably on the body 1 using round bolts 6a, 6b. The bolts 6a, 6b define a fixed rotational axis around which the outer parts 2a, 2c can be tilted upwards to form the chimney starter.

The at least two parts 2a, 2c can be held in their tilted positions by a movable bolt or a movable rod 10a, 10b, and the at least two parts 2a, 2c can be released by moving the bolt or the rod 10a, 10b and moved into an essentially non-tilted position by the effect of gravity. This allows for easily changing the position of the charcoal grate 2.

The at least two parts 2a, 2c may have suitable recesses 13a, 13b with which the round bolts 6a, 6b engage and which allow for tilting and a displacement, said at least two parts 2a, 2c optionally being held in their tilted positions by a locking mechanism 12a, 12b. The recesses 13a, 13b allow for horizontally displacing the at least two parts 2a, 2c to tilt them in another position. This allows for a more flexible use of the charcoal grate 2. The recesses 13a, 13b may, for example, be elongated holes or T-shaped holes.

A damping element 9 that decelerates the movement of the at least two parts 2a, 2c from their tilted positions into their essentially non-tilted positions and thus prevents any undesired scattering of the fuel may be provided on the body 1, on the at least two parts 2a, 2c or on the round bolts 6a, 6b. This allows for moving the charcoal grate 2 more slowly into its essentially non-tilted position and also into an essentially horizontal direction, which minimizes any sliding movements of the coal.

Directional baffles 4a, 4b for the coal can be arranged on the body 1. The directional baffles 4a, 4b allow for making the coal slide easily into a coal collecting area.

The charcoal grate 2 may be hollow. This allows for a light-weight construction.

The grill may comprise an ash pan 3. This allows for easily and comfortably removing ash from the grill.

The holes on the bottom side of the charcoal grate 2 may be larger than those on its top side. This allows for an improved air circulation.

The body 1 may have a pull-out starter pan 7. Starters, such as traditional cube-shaped grill lighters or a piece of wood or burning paper can be placed in the starter pan 7. The starter pan 7 can be pushed into the grill, and the starter will then light the coals. The starter pan 7 can be very delicate, as the coals fall through the starter pan 7 into the ash pan 3, when the grill is emptied.

In one embodiment limiting members 14a, 14b that form the space for the fuel together with the top sides of the at least two parts 2a, 2c can be arranged on the at least two parts 2a, 2c. This allows for forming a starter chimney in the grill enclosing the fuel using only a few movable parts. The limiting members 14a, 14b can consist of wires connected to form a lattice, of rods, of single metal or ceramic plates, embossed sheet metal or expanded metal. The limiting member 14a, 14b may be essentially parallel to the body.

The directional baffle 4a may have four bends that form four angles α, β, γ and δ and are defined as follows in a direction from the outside to the inside:

starting from an approximately horizontal part of the directional baffle 4a, there is an upward bend forming the angle α, followed by a bend in an approximately horizontal direction forming the angle β, followed by a downward bend forming the angle γ, followed by a bend approximately in a horizontal direction forming the angle δ,
the expressions “horizontal”, “upward” and “downward” being defined in relation to the use level,
the angles α, β, γ and δ being defined as follows:
α=110° to 130°, preferably 115° to 125°, especially 120°;
β=110° to 130°, preferably 115° to 125°, especially 120°;
γ=110° to 130°, preferably 115° to 125°, especially 120°;
δ=110° to 130°, preferably 115° to 125°, especially 120°.

This embodiment of the directional baffle 4a having four bends defining the above-mentioned angles results in the efficient removal of burnt coal or burnt briquettes. After having removed the center part 2b, the outer parts 2a, 2c are tilted upwards, the coals sliding downwards along the directional baffle 4a and falling into the ash pan 3. This provides for an easier removal of the used coal.

The directional baffle 4b may be symmetrical to the directional baffle 4a and has four bends that form four angles α′, β′, γ′ and δ′ and are defined as follows in a direction from the outside to the inside:

starting from an approximately horizontal part of the directional baffle 4b there is an upward bend forming the angle α′, followed by a bend approximately in a horizontal direction forming the angle β′, followed by a downward bend forming the angle γ′, followed by a bend in an approximately horizontal direction forming the angle δ′,
the expressions “horizontal”, “upward” and “downward” being defined in relation to the use level,
the angles α′, β′, γ′ and δ′ being defined as follows
α′=110° to 130°, preferably 115° to 125°, especially 120°;
β′=110° to 130°, preferably 115° to 125°, especially 120°;
γ′=110° to 130°, preferably 115° to 125°, especially 120°;
δ′=110° to 130°, preferably 115° to 125° especially 120°.

This embodiment of the directional baffle 4b having four bends defining the above-mentioned angles results in the efficient removal of burnt coal or burnt briquettes.

After having removed the center part 2b, the outer parts 2a, 2c are tilted upwards, the coals sliding downwards along the directional baffle 4b and falling into the ash pan 3. This provides for an easier removal of the used coal.

The sheet metal 8a may have two bends that form two angles φ and ψ and are defined as follows in a direction from the outside to the inside:

starting from an approximately horizontal part of the sheet metal 8a there is a downward bend forming the angle φ, followed by a bend in an approximately vertical direction forming the angle ψ,
the expressions “vertical” and “downward” being defined in relation to the use level, the angles φ and ψ being defined as follows:
φ=140° to 160°, preferably 145° to 155°, especially 150°;
ψ=110° to 130°, preferably 115° to 125°, especially 120°.

This embodiment of the sheet metal 8a having the above-mentioned angles and its combination with the directional baffles 4a provides an efficient way of discharging used coals. The outer parts 2a, 2c are tilted upwards, which allows the coals to slide into the ash pan 3.

The sheet metal 8b may be symmetrical to the sheet metal 8a and has two bends that form the angles φ′ and ψ′ and are defined as follows in a direction from the outside to the inside:

starting from an approximately horizontal part of the sheet metal 8b there is a downward bend forming the angle φ′, followed by a bend in an approximately vertical direction forming the angle ψ′,
the expressions “vertical” and “downward” being defined in relation to the use level, the angles φ′ and ψ′ being defined as follows:
φ′=140° to 160°, preferably 145° to 155°, especially 150°;
ψ′=110° to 130°, preferably 115° to 125°, especially 120°.

This embodiment of the sheet metal 8b having the above-mentioned angles and its combination with the directional baffles 4b provides an efficient way of discharging used coals. The outer parts 2a, 2c are tilted upwards, which allows the coals to slide into the ash pan 3.

The ratio of (the vertical distance between the top side of the outer part 2a or 2c and the section of the directional baffle 4a or 4b before the first bend) a and (the distance between the outer part 2a or 2c and the section of the directional baffle 4a or 4b between the first and second bends, measured in an orthogonal direction in relation to the section of the directional baffle 4a or 4b between the first and second bends) b a:b in the serviceable state may be approx. 7-11:11-15, preferably approx. 4-5:6-7, especially approx. 9:13. When the distance is selected in this way, the coals are prevented from not falling into the ash pan 3. In absolute terms, a may be approx. 7-11 mm, preferably approx. 8-10 mm, especially approx. 9 mm, and b may be approx. 11-15 mm, preferably approx. 12-14 mm, especially approx. 13 mm. As the size of the coals remains the same when the grill is resized, the distances do not have to be adjusted proportionally and the absolute dimensions can be maintained. The absolute dimensions have proved advantageous in combination with commercially available coals, independently of the grill's size.

The ratio of (the vertical distance between the top side of the outer part 2a or 2c and the section of the directional baffle 4a or 4b before the first bend) a′ and (the distance between the outer part 2a or 2c and the section of the directional baffle 4a or 4b between the first and second bends, measured in an orthogonal direction in relation to the section of the directional baffle 4a or 4b between the first and second bends) b′ in the tilted state of the outer parts 2a, 2c at a tilt angle of approx. 70° a′:b′ may be approx. 1-5:4-8, preferably approx. 2-4:5-7, especially approx. 1:2. When the distance is selected in this way, the coals are prevented from not falling into the ash pan 3. In absolute terms, a′ may be approx. 1-5 mm, preferably approx. 2-4 mm, especially approx. 3 mm; and b′ may be approx. 4-8 mm, preferably approx. 5-7 mm, especially approx. 6 mm. The absolute dimensions have proved advantageous in combination with commercially available coals, independently of the grill's size.

### Example 2

Grill with a three-part angular-shaped charcoal grate

The grill comprises a body 1, a cooking grate, an angular-shaped, preferably quadrilateral, charcoal grate 2 and an ash pan 3, said charcoal grate 2 having a top side and a bottom side and being hollow and having at least three parts 2a, 2b, 2c, the outer two parts 2a, 2c being arranged tiltably and the center part 2b being disposed removably on sheet metal 8a, 8b, and the charcoal grate 2 having holes on its top and bottom sides, directional baffles 4a, 4b for the coals being disposed on the body 1.

A division of the charcoal grate 2 into at least three parts 2a, 2b, 2c, the outer two parts 2a, 2b being arranged tiltably, has the advantage that the outer parts 2a, 2b can be tilted upwards. This allows for creating a cut-off “V” into which coals or briquettes can be added and where they can be lighted. This way, a chimney starter that is formed within the grill itself is created. Air may flow in from the bottom and from the sides and may thus create a chimney effect that allows for setting coals or briquettes completely aglow.

Carrying handles 5 can be disposed on the center part 2b. The carrying handles 5 allow for easily removing the center part 2b. The carrying handles 5 may be thermally insulated, so that users will not burn their fingers when touching them.

Further features, such as those described in Example 1, may also be present.

### Example 3

Grill with a Multi-Part Round Charcoal Grate

The grill comprises a body 1, a cooking grate, a round, preferably circular, charcoal grate 2 and an ash pan 3, said charcoal grate 2 having a top side and a bottom side and being hollow and having at least three parts 2a, 2b, 2c, the outer two parts 2a, 2c being arranged tiltably and the center part 2b being disposed removably on sheet metal 8a, 8b, and the charcoal grate 2 having holes on its top and bottom sides, directional baffles 4a, 4b for the coals being disposed on the body 1.

The charcoal grate 2 may consist of more than three parts, e.g., of 4, 5, 6, 7, 8, 9 or 10. In case of a round charcoal grate 2 that is circular or ellipsoid, a quadrilateral, preferably a square, can be inscribed into the circle or the ellipsis as center part 2b, the corners of said quadrilateral not contacting the circle or the ellipsis, i.e. the circle or the ellipsis is not the quadrilateral's circumscribed circle. Those parts that are directly adjacent to the edges of the inscribed quadrilateral are the tiltably arranged parts 2a, 2c and may be tilted upwards in order to be used as a chimney starter. Those parts that abut against the corners of the quadrilateral remain in their initial positions, just like the quadrilateral, thus forming the center part 2b parallel to the use level. In case of a round charcoal grate 2 having an inscribed quadrilateral, the round charcoal grate 2 thus consists of at least nine parts.

Carrying handles 5 can be disposed on the center part 2b. The carrying handles 5 allow for easily removing the center part 2b. The carrying handles 5 may be thermally insulated, so that users will not burn their fingers when touching them.

Further features, such as those described in Example 1, may also be present.

1.-23. (canceled)

24. A grill, comprising a body (1), a cooking grate and a charcoal grate (2), wherein the charcoal grate (2): has a top side and a bottom side and is permeable to air, has at least two parts (2a, 2c), said at least two parts (2a, 2c) being disposed tiltably and forming a space for fuel in their tilted position, said at least two parts (2a, 2c) are tiltable at an angle of 0° to 90° relative to a use level, said at least two parts (2a, 2c) are attached tiltably to the body (1) by means of round bolts (6a, 6b), and comprises holes on its top and bottom sides.

25. The grill according to claim 24, wherein
said at least two parts (2a, 2c) can be held in their tilted position by a movable bolt or a movable rod (10a, 10b) and said at least two parts (2a, 2c) are releasable by moving said bolt or said rod (10a, 10b) and are movable into an essentially non-tilted position by the effect of gravity.

26. The grill according to claim 24, wherein
said at least two parts (2a, 2c) have suitable recesses (13a, 13b) with which the round bolts (6a, 6b) engage, said at least two parts (2a, 2c) optionally being held in their tilted position by a locking mechanism (12a, 12b).

27. The grill according to claim 24, wherein
at least one damping element (9) that decelerates the movement of the at least two parts (2a, 2c) from their tilted position into their essentially non-tilted position and thus prevents the fuel from being undesirably scattered is disposed at the body (1), at the at least two parts (2a, 2c) or at the round bolts (6a, 6b).

28. The grill according to claim 24, wherein
it comprises at least one third part (2b), said third part (2b) being removably disposed in a holding device that is attached to the body (1) and serving as a support surface for the fuel.

29. The grill according to claim 28, wherein
said third part (2b) is removably disposed on sheet metal (8a, 8b).

30. The grill according to claim 24, wherein
directional baffles (4a, 4b) for charcoal are disposed on the body (1).

31. The grill according to claim 24, wherein
the charcoal grate (2) is hollow.

32. The grill according to claim 24, further comprising an ash pan (3).

33. The grill according to claim 28, wherein
carrying handles (5) are disposed on the third part (2b).

34. The grill according to claim 24, wherein
the holes on the bottom side of the charcoal grate (2) are larger than those on its top side.

35. The grill according to claim 24, wherein
the body (1) has a pull-out starter pan (7).

36. The grill according to claim 24, wherein
limiting members (14a, 14b) that form the space for the fuel together with the top side of the at least two parts (2a, 2c) are disposed on said at least two parts (2a, 2c).

37. The grill according to claim 30, wherein
the directional baffle (4a) has four bends that form four angles α, β, γ and δ which are defined as follows in a direction from the outside to the inside:
starting from an approximately horizontal part of the directional baffle (4a), there is an upward bend forming the angle α, followed by a bend in an approximately horizontal direction forming the angle β, followed by a downward bend forming the angle γ, followed by a bend approximately in a horizontal direction forming the angle δ,
the expressions “horizontal”, “upward” and “downward” being defined in relation to the use level, the angles α, β, γ and δ being defined as follows:
α=110° to 130°;
β=110° to 130°;
γ=110° to 130°;
δ=110° to 130°.

38. The grill according to claim 30, wherein
the directional baffle (4b) is symmetrical to the directional baffle (4a) and has four bends that form four angles α′, β′, γ′ and δ′ which are defined as follows in a direction from the outside to the inside:
starting from an approximately horizontal part of the directional baffle (4b) there is an upward bend forming the angle α′, followed by a bend approximately in a horizontal direction forming the angle β′, followed by a downward bend forming the angle γ′, followed by a bend in an approximately horizontal direction forming the angle δ′,
the expressions “horizontal”, “upward” and “downward” being defined in relation to the use level, the angles α′, β′, γ′ and δ′ being defined as follows
α′=110° to 130°;
β′=110° to 130°;
γ′=110° to 130°;
δ′=110° to 130°.

39. The grill according to claim 29, wherein
the sheet metal (8a) has two bends that form two angles φ and ψ which are defined as follows in a direction from the outside to the inside:
starting from an approximately horizontal part of the sheet metal (8a) there is a downward bend forming the angle φ, followed by a bend in an approximately vertical direction forming the angle ψ,
the expressions “vertical” and “downward” being defined in relation to the use level, the angles φ and ψ being defined as follows:
φ=140° to 160°;
ψ=110° to 130°.

40. The grill according to claim 29, wherein
the sheet metal (8b) is symmetrical to the sheet metal (8a) and has two bends that form the angles φ′ and γ′ which are defined as follows in a direction from the outside to the inside:
starting from an approximately horizontal part of the sheet metal (8b) there is a downward bend forming the angle φ′, followed by a bend in an approximately vertical direction forming the angle ψ′,
the expressions “vertical” and “downward” being defined in relation to the use level,
the angles φ′ and ψ′ being defined as follows:
φ′=1400 to 160°;
γ′=110° to 130°.

41. The grill according to claim 30, wherein
the ratio of (the vertical distance between the top side of the outer part (2a or 2c) and the section of the directional baffle (4a or 4b) before the first bend) a and (the distance between the outer part (2a or 2c) and the section of the directional baffle (4a or 4b) between the first and second bends, measured in an orthogonal direction in relation to the section of the directional baffle (4a or 4b) between the first and second bends) b a:b in the serviceable state is approximately 7-11:11-15.

42. The grill according to claim 41, wherein
a is approximately 7-11 mm, and
b is approximately 11-15 mm.

43. The grill according to claim 30, wherein
the ratio of (the vertical distance between the top side of the outer part (2a or 2c) and the section of the directional baffle (4a or 4b) before the first bend) a′ and (the distance between the outer part (2a or 2c) and the section of the directional baffle (4a or 4b) between the first and second bends, measured in an orthogonal direction in relation to the section of the directional baffle (4a or 4b) between the first and second bends) b′ in the tilted state is of the outer parts (2a, 2c) at a tilt angle of approximately 70° a′:b′ is approximately 1-5:4-8.

44. The grill according to claim 43, wherein
a′ is approximately 1-5 mm; and
b′ is approximately 4-8 mm.
